(19) United States
(12) Patent Application Publication
(10) Pub. No.: US 2006/0138877 A1
(43) Pub. Date: Jun. 29, 2006

(54) Rotor core for motor and small motor

(76) Inventor: Makoto Akabane, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/291,659

(22) Filed: Nov. 30, 2005

(30) Foreign Application Priority Data
Nov. 30, 2004 (JP) 2004-347857

(51) Int. Cl. H02K 1/04; H02K 5/16

(52) U.S. Cl. 310/43; 310/215; 310/90; 310/217

(57) ABSTRACT

A rotor core for a motor includes a core having a plurality of core sheets which are laminated, a rotation shaft which is press-fitted to the core, a press-fitting part and at least a space part which are provided at a joining portion of a through-hole of each of the core sheets to the rotation shaft, and a resin film which is formed in the space part for joining the rotation shaft with the core.

### CROSS-REFERENCE TO RELATED APPLICATIONS

This application claims priority to Japanese Application No. 2004-347857 filed Nov. 30, 2004, which is incorporated herein by reference.

### FIELD OF THE INVENTION

The present invention relates to a small motor which is used for driving a lens of a camera or which is used in the field of information equipment, for example, a recording/reproducing device such as a CD or a DVD, and specifically the present invention relates to a rotor core for a motor.

### BACKGROUND OF THE INVENTION

Recently, the size of a motor which is used in an information equipment such as a portable personal computer has been required to be further reduced. With downsizing of a rotor core in which the rotation shaft of a motor used in an information equipment is press-fitted to a core, problems such as sliding noise of a bearing caused by deflection or damage of the rotation shaft, noise caused by shaft displacement, and reliability reduction of a motor caused by deflection or damage of the rotation shaft have occurred.

Conventionally, in an inner rotor type of motor which is often used in an information equipment described above, a rotation shaft is press-fitted to a through-hole of a core in which a plurality of core sheets is laminated and fixed. Various methods for fixing a plurality of core sheets to be laminated have been known. For example, a fixing method with the use of a dowel formed in the core sheet, a method in which, after a plurality of core sheets are laminated, film is formed on their surfaces by powder coating or the like and the plurality of core sheets are fixed, and a method in which a plurality of core sheets laminated is fixed by using laser welding have been proposed. Alternatively, without press-fitting a rotation shaft to a core, the rotation shaft may be joined to the core such that the rotation shaft is inserted into the core and caulking is performed near the rotation shaft on the core end face side.

In order to attain the downsizing of a motor to cope with the downsizing of an information equipment, downsizing of a rotor core which is used in the motor is required.

A plurality of core sheets constructing a core is respectively provided with a through-hole by individual working. Therefore, when a plurality of core sheets are laminated with the outside form of a core sheet as a reference, the variation of a through-hole (hole shape and hole position) of the respective core sheets occurs. This variation causes the deflection and damage of the rotation shaft when the rotation shaft is press-fitted.

A method in which a rotation shaft is press-fitted to a laminated core has been used conventionally, but recently the diameter of the rotation shaft is made smaller due to downsizing of a motor and thus its mechanical strength is decreased. As a result, when the rotation shaft is press-fitted to the laminated core with the same press-fitting margin as before, since the rotation shaft is not provided with a mechanical strength capable of correcting the positional displacements of the through-holes of the laminated core sheets and thus deformation or damage occurs in the rotation shaft.

When the press-fitting margin is set to be small, the deflection of the rotor shaft is reduced and thus it is effective to restrain the damage of the surface of the rotor shaft. However, the joining strength between the core and the rotor shaft becomes insufficient and thus a whirl-stop is separately required to prevent positional shifting of the core due to impact or to restrain positional displacement of the core in the rotational direction.

In order to avoid deflection or surface damage of a rotor shaft, another method has been known in which the rotor shaft is inserted into a through-hole and a laminated core is joined with the rotor shaft by caulking. However, when the core and the rotor shaft is joined with sufficient strength by caulking, the core sheets may be unnecessarily deformed by caulking force to cause the rotor shaft to deform. Further, the iron loss is increased by the deformation of the core sheets and thus motor characteristics are reduced. In addition, when the number of sheets of the laminated core is increased, the caulking force in the inner core sheets decreases in comparison with that in both end faces of the core and thus the core sheet may idle or shift.

### OBJECT AND SUMMARY OF THE INVENTION

In view of the above-mentioned problems, it is an object and advantage of the present invention to provide a rotor core which is capable of being produced while deflection and damage of a rotation shaft are restricted and to provide a motor with high reliability and little noise.

In order to achieve the above object and advantage, according to an embodiment, there is provided a rotor core for motor including a core which is constructed of a plurality of core sheets which are laminated, and a rotation shaft which is press-fitted to the core. In the rotor core, each of the core sheets is provided with a press-fitting part and at least a space part which are formed at the joining portion of the through-hole of the core sheet to the rotation shaft and resin film is formed in the space part for joining the rotation shaft with the core.

In accordance with an embodiment, a press-fitting part and space parts are formed in the peripheral part of the through-hole of a core which is constructed of a plurality of laminated core sheets for joining the core with the rotation shaft when the rotation shaft is press-fitted to the core. Therefore, press-in force when the rotation shaft is press-fitted to the core can be reduced, and deflection and damage of the rotation shaft can be restricted. In addition, the space part of the core sheet serves as a thickness relief part for the core sheet or the rotation shaft when deformed by the press fitting. Therefore, deflection of the rotation shaft and deformation of the core sheet can be prevented. Further, joining area of the core with the rotation shaft for resin film is increased by forming the resin film in the space part and thus the rotation shaft is firmly joined to the core.

In accordance with an embodiment, the resin film is preferably formed in the space part and the outer surface of the core. According to the construction described above, resin film covering the outer surface of the core and resin film formed in the space part of the through-hole of the rotor core to which the rotation shaft is fitted can be performed in one film production step. Therefore, formation of resin film for preventing breakage of the film of a winding coil of the rotor coil by the edge part of the core sheet which is formed of an electromagnetic steel plate punched in a desired shape by pressing process and firm joining of the rotor core with the rotation shaft can be simultaneously performed and thus manufacturing process can be simplified. Further, problems such as cracking and peeling of resin film can be eliminated, which are caused by press-fitting stress and caulking stress in the joining method of the core with the rotation shaft in which, after the resin film has been formed on the rotor core, the rotation shaft is press-fitted or the rotation shaft is inserted and performed with caulking.

In accordance with an embodiment, the space parts of the core sheets are preferably laminated in an aligned state. According to the construction described above, resin material is easily adhered to the space part formed in the through-hole of the core sheet. Therefore, the joining area of the core with the rotation shaft is increased and thus the rotation shaft is firmly joined to the core.

In accordance with an embodiment, it is preferable that a plurality of the space parts is concentrically formed with a substantially equal interval with respect to the rotation shaft. According to the construction described above, joining without deflection of the core with the rotation shaft can be attained, the deflection of the rotation shaft at the time of press fitting is prevented, and uniform and firm joining can be realized. Further, when the space parts are provided by positive integer multiples of the number of core teeth, the core can be formed in which the space parts are laminated in alignment, even when the core sheets are laminated irrespective of the front face and the rear face of a sheet, by laminating only the teeth position being aligned. Therefore, occurrence of defect can be prevented and production control can be simplified.

In accordance with an embodiment, it is preferable that the resin film is insulating resin film. According to the construction described above, joining of the core with the rotation shaft and formation of the insulating resin film for preventing short circuit between a winding coil and the core are performed in the same step and thus processing steps are simplified. Epoxy-based resin, polyimide-based resin, acrylic-based resin or the like may be used as the insulating resin film material. Dipping, blasting, electrostatic coating (including powder coating), and electro-deposition coating may be used for a film production method.

In accordance with an embodiment, it is preferable that the resin film is polyimide-based resin film. According to the construction described above, the resin film with the thickness of 10 μm through 40 μm can provide satisfactory electric insulation property, mechanical strength, adhesion property, corrosion resistance and heat-resistance. Therefore, the number of turns of the winding coil can be increased and thus the characteristic of a motor is improved in comparison with a motor in the same dimension.

In accordance with an embodiment, it is preferable that the resin film is electro-deposition coating film. According to the construction described above, since thin film with uniform film thickness and excellent coating property for step portion can be formed, satisfactory insulating film can be formed on the core having step portions due to being laminated. Therefore, a winding coil can be wound around the rotor core more and thus the characteristic of a motor is improved in comparison with a motor in the same dimension.

Further, according to an embodiment, there is provided a small motor including the above-mentioned rotor core in which the core sheet is formed of an electromagnetic steel plate, a rotor coil which is constructed of a winding coil wound around the rotor core, and a stator magnet which is disposed so as to face the rotor coil. The rotating force is obtained by electromagnetic interaction of magnetic field generated when the rotor coil is energized. According to the construction described above, deflection of the rotation shaft and damage causing noise are remarkably reduced. Therefore, a small motor can be obtained without lowering reliability of motor based on sliding noise, noise due to shaft displacement and deflection or damage of the rotation shaft.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a sectional side view showing a motor in accordance with a first embodiment of the present invention.

FIG. 2 is a sectional view showing the motor in accordance with the first embodiment.

FIG. 3(1) is a top plan view showing a core sheet and a sectional side view showing a rotor core in accordance with the first embodiment, in the state that a rotor shaft is not press-fitted to the rotor core. FIG. 3(2) is a top plan view showing a core sheet and a sectional side view showing a rotor core in accordance with the first embodiment, in the state that resin film has been formed on the rotor core. FIG. 3(3) is an explanatory side view showing the rotor core and the rotor part in accordance with the first embodiment.

FIG. 4(1) is a top plan view showing a through-hole of a core sheet in accordance with a second embodiment of the present invention. FIG. 4(2) is a top plan view showing a through-hole of a core sheet in accordance with a third embodiment. FIG. 4(3) is a top plan view showing a through-hole of a core sheet in accordance with a fourth embodiment

### DESCRIPTION OF THE PREFERRED EMBODIMENTS

Embodiments of the present invention will be described below with the reference to the accompanying drawings.

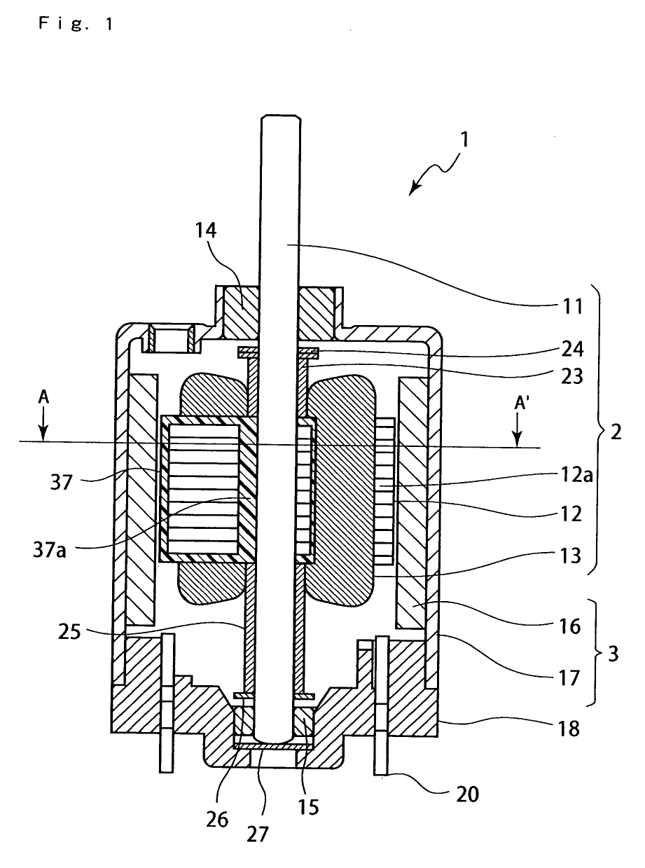

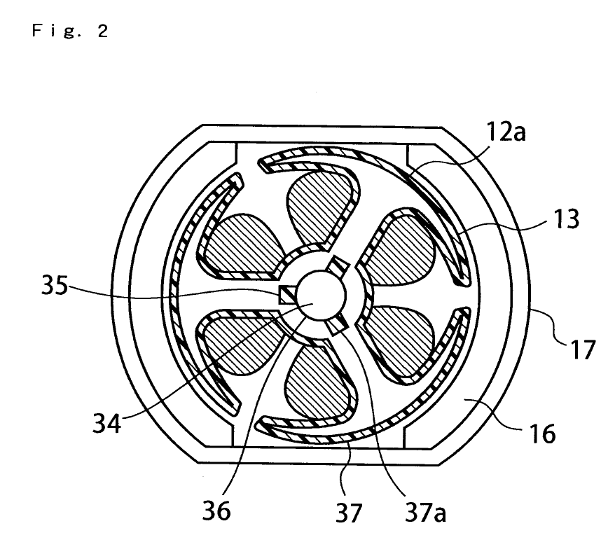

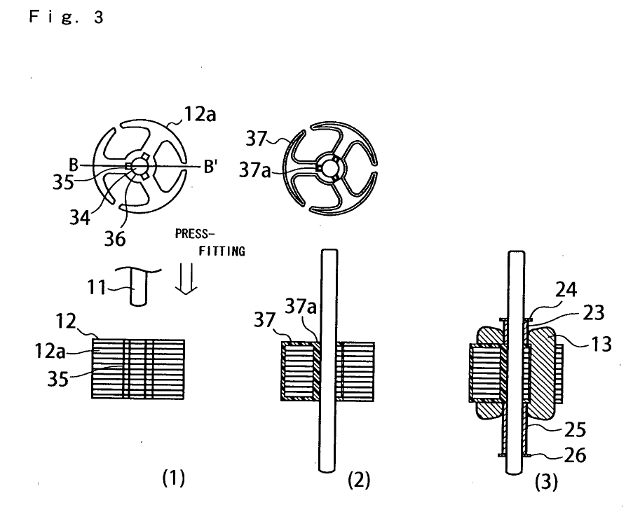

FIG. 1 is a sectional view showing a motor in accordance with a first embodiment of the present invention. FIG. 2 is a sectional view showing “A-A′” art in FIG. 1 which is cut in a direction perpendicular to the rotor shaft of the motor in accordance with the first embodiment. FIGS. 3(1), 3(2) and 3(3) are views showing a process in which a rotor shaft is press-fitted to a laminated core, resin film is formed in space parts of core sheets and, after that, a coil is wound around a rotor core in which the rotor shaft and the core are joined together to construct a rotor part. The rotor core means a combination of a rotor shaft and a core, in which the rotor shaft is joined to the core by press fitting and the resin film in the space part. A rotor coil means a coil in the state that a winding coil is wound around the rotor core.

In FIG. 1, a motor 1 is constructed such that a rotor shaft 11 made of stainless steel is press-fitted to a core 12 formed of laminated core sheets 12a and a coil winding 13 is wound around the rotor core. The motor 1 is rotatably supported by a bearing 14 provided on a motor cover 17 and a bearing 15 provided on a motor holder 18. A stator magnet 16 made of permanent magnet is fixed at a position facing the core 12 in the inside of the motor cover 17.

The rotation shaft 11 constructing the rotor part 2 is press-fitted to the core 12 comprising of laminated core sheets 12a and joined by resin film which is formed between the space part formed in the core sheets 12a and the rotation shaft 11. The resin film is also formed on the outer surface of the core 12. A winding coil 13 is wound around the core 12 by a prescribed number of times to form a rotor coil. The rotation shaft 11 is provided with bushes 23, 25 and washers 24, 26 for setting the position of the core 12 with respect to the bearings 14, 15 in a constant state.

FIG. 2 is a transversal sectional view showing the structure of a motor which is cut by the line “A-A” in FIG. 1. A through-hole 34 is formed at the center portion of the core sheet 12a which is press-worked on an electromagnetic steel plate in a prescribed shape. The through-hole 34 is provided with a press-fitting part 36, which is to be press-fitted and joined with the rotation shaft 11, and a space part 35 which forms a space between the rotation shaft 11 and the core sheet 12a after the rotation shaft 11 is press-fitted to the core 12. When the rotation shaft 11 is press-fitted to the core 12, the press-fitting part 36 is fitted and joined to the rotation shaft 11. In this state, a space is formed between the rotation shaft 11 and the core sheet 12a in the space part 35.

Stator magnets 16 made of permanent magnet which construct the stator part 3 are fixed to the inside of the motor cover 16. In an embodiment of the present invention, the motor cover 17 is formed in an oval sectional shape but may be formed in a circular shape or a polygonal shape. The stator magnets 16 utilize a divided magnet but may be formed with one piece of magnet that is polarized and magnetized.

The bearing 14 for rotatably supporting the rotation shaft 11 is provided in the motor cover 17. The bearing 14 is press-fitted and fixed to a rising part which is formed in a part of the motor cover 11 by burring working or the like.

The motor holder 18 is provided with the bearing 15 rotatably supporting the rotation shaft 11, a thrust plate 27 and external electrodes 20. In accordance with an embodiment, an oil retaining bearing is used as the bearings 14, 15. A stepped part is formed in the motor holder 18 for engaging with the motor cover 17. The stepped part of the motor holder 18 and the opening end part of the motor cover 17 are engaged with each other and the motor cover 17 is integrated with the motor holder 18.

FIG. 3(1) shows a core sheet 12a in the state before the rotation shaft 11 is press-fitted and is a cross-sectional view showing the rotor core which is cut by the line of “B-B′” in the core sheet 12a. A plurality of core sheets 12a which is formed such that an electromagnetic steel plate is punched in a prescribed shape by press working are laminated to construct the core 12 by using a fixing jig (not shown) for stacking in alignment. In the core sheet 12a that is individually press-worked, variation of the hole diameter and the hole position of the through-hole 34 occurs. Therefore, a clearance more than the amount of the variation is provided in the jig for stacking in alignment. The rotation shaft 11 is press-fitted to the through-holes 34 of the core 12 in the state that the core sheets 12a are stacked in alignment but are not fixed to each other. In this state, a core sheet 12a in which the center position of the through-hole 34 deviates from the center position of the rotation shaft 11 moves in a direction such that the center position of the through-hole 34 coincides with the center position of the rotation shaft 11 due to the press fitting force at the time of press fitting of the rotation shaft 11. This movement causes the non-uniform press-fitting stress which is applied to the rotation shaft 11 to reduce. Therefore, in accordance with an embodiment, non-uniform press-fitting stress which causes the rotation shaft 11 to deflect can be remarkably reduced in comparison with the core 12 which is constructed such that core sheets 12a are laminated and fixed to each other in the state where variations of the hole diameter and the hole position of the through-hole 34 of the core sheet 12a which is individually press-worked and positional deviations at the time of stacking in alignment and fixing to each other are accumulated.

According to an embodiment of the present invention, since the core sheets 12a are capable of moving at the time of press fitting, the press-fitting margin can be reduced in comparison with the press-fitting margin for the conventional core 12 which is constructed such that the core sheets 12a are laminated and fixed to each other. Therefore, deflection and damage of the rotation shaft 11 occurred at the time of press fitting can be reduced by setting the press-fitting margin to be small.

Reducing the press-fitting margin is effective to reduce the stress due to press-fitting. On the other hand, variations of the hole shape and hole position of the through-hole 34 of the core sheet 12a are required to be small and accuracy for laminating and stacking of the core sheets 12a is required to be enhanced. Therefore, component yield may be reduced and production control may be complicated to cause cost to increase. However, in an embodiment, press-fitting force can be adjusted by changing the ratio of the press-fitting part 36 formed in the through-hole 34 and the space part 35. Therefore, the press-fitting force can be adjusted without occurring the problems described above and thus the deflection and damage of the rotation shaft can be prevented or decreased.

FIG. 3(2) shows the core sheet 12a whose outer peripheral part is coated with resin film and the state where the outer side face of the core 12 to which the rotation shaft 11 is press-fitted and the space part 35 are formed with resin film 37a. FIG. 3(2) is a top plan view showing the core sheet 12a and a cross-sectional side view showing the rotor core which is cut by the line of “B-B′” in the core sheet 12a similarly FIG. 3(1). The resin film 37 is not shown in the right side portion of the core in the cross-sectional side view but the resin film is formed on the entire outer side face of the core 12.

In the core 12 to which the rotation shaft 11 is press-fitted, joining force of the core 12 with the rotation shaft 11 is designed such that positional deviation does not occur in the core 12 or the core sheets 12a when the resin film 37a is formed at least in the space part 35.

The resin film 37a is formed in the space part 35 of the core 12 to which the rotation shaft 11 is press-fitted by dipping, blasting, electrostatic coating (powder coating is included), or electro-deposition coating. The resin film 37a is formed in the space part 35 formed by the core sheets 12a and the rotation shaft 11 to firmly join the core 12 with the rotation shaft 11. Sufficient joining force in practical use of a motor is ensured by the joining of the press fitting to the core 12 and the joining of the resin film 37a in the space part 35. Alternatively, even when the resin film 37a is not completely formed in the space parts 35 of the core sheets 12a constructing the core 12, sufficient joining force is ensured in practical use of a motor.

After the rotation shaft 11 is press-fitted to the core 12, the resin film 37, 37a on the outer side face of the core 12 and the space part 35 may be formed with the same resin in the same step, with the same resin in different steps, or with different resins in different steps. Therefore, a degree of freedom in processing steps is enhanced. When the resin films 37, 37a are formed with the same resin in the same step, a masking step for preventing formation of resin film to unnecessary portions is reduced and thus processing merit can be obtained. Further, in comparison with a method where the rotation shaft 11 is press-fitted to the core 12 after the resin film 37 has been formed or a method where the rotation shaft 11 and the core 12 are joined by means of that the rotation shaft 11 is inserted and performed with caulking to the core 12 after the resin film 37 has been formed to the core 12, cracking and peeling of the resin film due to the stress of press fitting or caulking can be eliminated.

In accordance with an embodiment, the space part 35 is preferably formed to be laminated in an aligned state. When the space part 35 is in an aligned state, film material is easily entered into the space part 35 at the time of forming the resin film 37a in the space part 35 and thus film production time period is easily shortened and the joining area is easily increased. In the embodiment shown in FIG. 3(2), the space parts 35 are laminated in an aligned state in the core 12 and thus the space parts 35 are in communication with each other.

The resin film material is preferably a material which is provided with a high degree of adhesion property (joining strength) between the core 12 and the rotation shaft 11 and, in which thin film coating with a thickness of about several decades μm can be performed with a uniform film thickness, and superior in coating property for step portion. When the size of a motor is reduced, the coil winding space in the core 12 is also decreased. However, in accordance with an embodiment, the winding coil 13 can be wound more by using resin material capable of forming thin film with a high degree of coating property for step portion and thus motor characteristic can be enhanced.

The resin material is preferably provided with insulation property. When insulating resin is used, the formation of the resin film 37a in the space part 35 and the formation of the insulating resin film 37 for preventing short circuit between the winding coil 13 and the core 12 are performed in the same step and thus processing steps are simplified.

Polyimide-based resin, epoxy-based resin, acrylic-based resin or the like may be used as the insulating resin film material. Polyimide film and epoxy film can be formed in a uniform thin film and are superior in adhesion property with base material, corrosion resistance and electric insulation property. Especially, polyimide-based resin is provided with a high degree of heat-resistance and thus it is suitable for an information equipment which is used in a high environmental temperature state such as a car because of its high reliability.

Dipping, blasting, electrostatic coating (including powder coating), and electro-deposition coating may be used for a film production method. Electro-deposition coating and powder coating are suitable as a coating method because uniform thin film coating is possible, a high degree of coating property for step portion and adhesion property are obtained. Especially, electro-deposition coating can provide resin film with a high degree of adhesion property and with less pinhole without performing heat-treatment after resin film has been formed. Polyimide-based resin formed by electro-deposition coating is superior in adhesion property, corrosion resistance, electric insulation property and heat-resistance with film thickness of 10-15 μm.

FIG. 3(3) shows the rotor part 2 in which the winding coil 13 is wound around the core 12 and the bushes 23, 25 and the washers 24, 26 are mounted on the rotation shaft 11. FIG. 3(3) is a cross-sectional side view showing the rotor core which is cut by the line of “B-B′” in the core sheet 12a similarly in FIG. 3(2). The resin film 37 is not shown in the right side portion of the core in the cross-sectional side view but the resin film is formed on the entire outer side face of the core 12.

The resin film 37 is formed on the core 12 and further the winding coil 13 is wound around the arm parts of the core 12 over the resin film 37. The bushes 23, 25 are inserted or press-fitted to the rotation shaft and disposed at prescribed positions in order to set the distance between the bearings 14, 15 and the core 12 of the motor 1 in a prescribed state. In addition, washers 24, 26 are inserted or press-fitted to the rotation shaft 11 on the end part sides of the bushes 23, 25.

In the motor constructed as described above, deflection of the rotation shaft and damage causing noise are remarkably reduced in comparison with a rotor core in which the rotation shaft 11 is press-fitted to a conventional laminated and fixed core 12 or a rotor core in which the rotation shaft 11 is fixed to core 12 which is laminated and fixed by caulking. Therefore, a small motor can be obtained without lowering reliability of motor due to sliding noise, noise due to shaft displacement and deflection or damage of the rotation shaft.

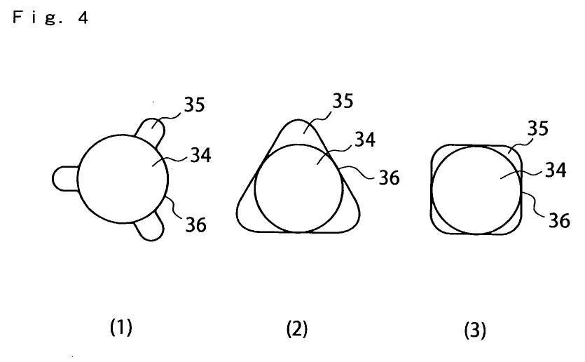

FIGS. 4(1), 4(2) and 4(3) show through-holes 34 provided in the core sheet 12a which are other embodiments of the present invention. In an embodiment shown in FIG. 4(1), the press-fitting part 36 is formed in a circular arc shape. A taper is provided in a boundary portion of the space part 35 and the press-fitting part 36. The taper at the boundary portion is formed to prevent the rotation shaft 11 from being damaged by the edge part of the boundary portion when the rotation shaft 11 is press-fitted.

In an embodiment shown in FIG. 4(2), the through-hole 34 is formed in a roughly triangular shape in which three sides are respectively used as the press-fitting part 36 and three corner parts are used as the space part 35. In FIG. 4(3), the through-hole 34 is formed in a roughly rectangular shape in which four sides are respectively used as the press-fitting part 36 and each corner part is used as the space part 35.

As described in the above-mentioned other embodiments, the press-fitting parts 36 are preferable formed in a symmetrical manner with respect to the rotation shaft 11. This is because that variation of joining force between the respective core sheets 12a and the rotation shaft 11 in the surface direction of the core sheet 12a can be effectively reduced and misalignment of the center of the rotation shaft 11 and the center of the core 12 when the rotation shaft 11 is press-fitted can be effectively restricted.

The space parts 35 are preferably formed in a symmetrical manner with respect to the rotation shaft similarly to the press-fitting part 36. According to the construction described above, joining without deflection of the core 12 with the rotation shaft 11 can be attained and the deflection of the rotation shaft at the time of press fitting is prevented and, uniform and firm joining can be realized. Further, when the space parts are provided by positive integer multiples of the teeth number of the core 12, the core 12 can be formed in which the space parts 35 are laminated in alignment even when the core sheets 12a are laminated irrespective of the front face and the rear face of a sheet by laminating only the teeth position being aligned. Therefore, occurrence of defect can be prevented and production control can be simplified.

The size of the space part 35 may be determined based on the ratio of the press-fitting part 36 and the space part 35, the diameter of the rotation shaft 11, the length of the core 12 (laminated sheet number of the core sheets 12a), and the resin material and forming method of the resin film 37a which is formed in the space part 35.

For example, it is confirmed for the rotor core constructed under the following conditions that deflection and damage of the rotation shaft 11 do not cause a problem in practical use and the resin film 37a is formed in the space part 35 and the rotation shaft 11 is coupled to the core 12 with sufficient joining force.

The conditions of the rotor core are as follows:
the shape of the space part 35 is shown in FIG. 4(1);
the diameter of the rotation shaft 11 is 1 mm;
the width of the opening edge of the bell-shaped space part 35 is 0.3 mm and its length is 0.3 mm;
the length of the core 12 is 3.5 mm, its outer diameter is 8 mm;
the thickness of the core sheet is 0.35 mm;
the press-fitting margin of the rotation shaft 11 and the core 12 is 5-20 μM; and
the resin film formed in the space part 35 is polyimide-based film formed by electro-deposition coating (10-15 μm, variation is included).

The present invention has been described in detail using the embodiments, but the present invention is not limited to the embodiments described above and many modifications can be made without departing from the present invention.

As described above, in the rotor core and the motor in accordance with an embodiment of the present invention, the press-fitting part and the space part are provided in the through-hole of the core sheet and the rotation shaft is press-fitted to the core which is constructed by the laminated core sheets, and further, the resin film which joins the core with the rotation shaft is formed in the space part. Therefore, since the rotor core in which deflection and damage of the rotation shaft are restricted can be formed, a small-sized motor with little noise and high reliability can be provided.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotor core for a motor comprising:
a core including a plurality of core sheets which are laminated;
a rotation shaft which is press-fitted to the core;
a press-fitting part and at least a space part which are provided at a joining portion of a through-hole of each of the core sheets to the rotation shaft; and
resin film which is formed in the space part for joining the rotation shaft with the core.

2. The rotor core for motor according to claim 1, wherein the resin film is formed in the space part and an outer surface of the core.

3. The rotor core for motor according to claim 1, wherein the space parts of the core sheets are laminated in an aligned state.

4. The rotor core for motor according to claim 1, wherein a plurality of the space parts is concentrically formed with a substantially equal interval with respect to the rotation shaft.

5. The rotor core for motor according to claim 2, wherein the resin film is insulating resin film.

6. The rotor core for motor according to claim 2, wherein the resin film is polyimide-based resin film.

7. The rotor core for motor according to claim 2, wherein the resin film is electro-deposition coating film.

8. A small motor comprising:
the rotor core as recited in claim 1 in which the core sheet is formed of an electromagnetic steel plate;
a rotor coil which is constructed of a winding coil wound around the rotor core; and
a stator magnet which is disposed so as to face the rotor coil;
wherein rotating force is obtained by electromagnetic interaction of a magnetic field generated when the rotor coil is energized.

9. A small motor comprising:
the rotor core as recited in claim 1;
a rotor coil which is wound around the rotor core; and
a stator magnet which is disposed so as to face the rotor coil.

10. The small motor according to claim 9, wherein insulating resin film is formed in the space part and an outer surface of the rotor core.

11. The small motor according to claim 10, wherein the resin film that is polyimide-based resin film.
